(19) United States
(12) Patent Application Publication
(10) Pub. No.: US 2007/0065776 A1
(43) Pub. Date: Mar. 22, 2007

(54) Extension devices for dental handpiece

(76) Inventor: Yechiel Cohen, Carmiel (IL)

Correspondence Address: Martin D. Moynihan;PRTSI, Inc., P.O. Box 16446, Arlington, VA, 22215, US

(21) Appl. No.: 11/601,782

(22) Filed: Nov. 20, 2006

Related U.S. Application Data
(63) Continuation-in-part of application No. 10/948,395, filed on Sep. 24, 2004, now abandoned.

(30) Foreign Application Priority Data
Dec. 30, 2003 (IL) 159652

(51) Int. Cl. A61C 1/14

(52) U.S. Cl. 433/129

(57) ABSTRACT

An extension device for dental handpieces for extending the effective length of a dental tool to be clamped within the dental handpiece. The extension device includes an extension unit including a shaft at one end to be clamped within the dental handpiece instead of a dental tool, and a sleeve having a radially-contractible section at the opposite end for receiving a dental tool; and a clamping unit applicable over the radially-contractible section of the sleeve, after having received a dental tool, for securely clamping the dental tool within the sleeve. Also described are a high-speed dental handpiece in which the extension device is particularly useful, and an arrangement for providing lateral support to the extension device when included in the dental handpiece.

### RELATED APPLICATIONS

This application is a Continuation-In-Part (CIP) of pending U.S. patent application Ser. No. 10/948,395 filed on Sep. 24, 2004, which claims the benefit of Israel Patent Application No. 159652 filed on Dec. 30, 2003. The contents of the above Applications are all incorporated herein by reference.

### FIELD AND BACKGROUND OF THE INVENTION

The present invention relates to extension devices for dental handpieces for extending the effective length of a dental tool. The invention also relates to dental handpieces including such extension devices. The invention is particularly useful with respect to the dental handpiece described in Israel Patent 107202 of Oct. 6, 1993, and corresponding U.S. Pat. No. 5,549,474 of Aug. 27, 1996, and U.S. Pat. No. 5,810,588 of Sep. 22, 1998, and is therefore described below, for purposes of example only, with respect to such dental handpieces. It will be appreciated, however, that the invention could also be used with other dental handpieces, for example those described in my concurrently-filed US application titled “Clamping Device and Dental Handpiece Including Same”.

The above-cited patents and patent application describe a dental handpiece comprising a housing including a hand-gripping section at one end, and a tool-clamping section at the opposite end. The tool-clamping section includes a sleeve for receiving a shaft of a dental tool, such as a drill or bur, and a collet or chuck for clamping the shaft of the dental tool within the sleeve. The dental handpiece further includes a button carried by the housing and depressible to cause the collet to release the shaft of the dental tool in order to permit convenient removable and replacement of the dental tool. Such dental handpieces are particularly useful with an air turbine for driving the dental tool at extremely high speeds, in the order of 400,000 rpm.

It has been found that the use of dental handpieces in general, and particularly the dental handpieces described in the above-cited patents and concurrently-filed patent application, can be easily adapted for many different dental operations if the effective length of the dental tool can be increased in a quick and convenient manner. This is particularly true when the dental handpiece is used for preparing implants involving drilling holes of different depths into the patient's bone for receiving the implant.

### OBJECTS AND BRIEF SUMMARY OF THE PRESENT INVENTION

One object of the present invention is to provide an extension device for dental handpieces for extending the effective length of a dental tool to be clamped within the dental handpiece in order to enable the dental handpiece to be used for a wide variety of dental operations. Another object of the present invention is to provide a dental handpiece with an extension device which permits the effective length of the dental tooth to be increased in a convenient manner, and thereby permits more convenient use of the dental handpiece for many different dental operations.

According to one aspect of the present invention, there is provided an extension device for dental handpieces for extending the effective length of a dental tool to be clamped within the dental handpiece, the extension device comprising: an extension unit including a shaft at one end to be clamped within the dental handpiece instead of a dental tool, and a sleeve having a radially-contractible section at the opposite end for receiving a dental tool; and a clamping unit applicable over the radially-contractible section of the sleeve, after having received a dental tool, for securely clamping the dental tool within the sleeve of the extension unit.

According to a further feature in the described preferred embodiments, the shaft of the extension unit has a uniform outer diameter and a smooth, uninterrupted outer cylindrical surface, such as to enable the extension unit to be clamped within a high-speed dental handpiece to operate at over 100,000 RPM.

According to still further features in the described preferred embodiments, the sleeve of the extension unit is integrally formed with the shaft and includes an externally-threaded surface between the radially-contractible section of the sleeve and the shaft. The clamping unit includes an internally-threaded surface threadable within the externally-threaded surface of the sleeve, and an inner conical surface engageable with the radially-contractible section of the sleeve, after having received a dental tool, for securing clamping the dental tool therein.

According to another aspect of the present invention, there is provided a dental handpiece, comprising: a housing including a hand-gripping section at one end, and a tool clamping section at the opposite end; a collet within the tool-clamping section of the housing for releasably clamping therein the shaft of a dental tool; and an extension device for extending the effective length of a dental tool to be clamped within the dental handpiece; the extension device comprising; an extension unit including a shaft at one end to be clamped within the dental handpiece instead of a dental tool, and a sleeve having a radially-contractible section at the opposite end for receiving a dental tool; and a clamping unit applicable over the radially-contractible section of the sleeve, after having received a dental tool, for securely clamping the dental tool within the sleeve of the extension unit.

In the described preferred embodiments, the housing further includes an air turbine for rotating the dental handpiece at a high speed when the extension device is clamped within the dental handpiece and a tool is clamped within the extension device.

According to further preferred features of the invention, the housing further includes a rotary bearing engageable with the extension piece, when mounted within the housing, to provide lateral support therefor during the rotation of the extension piece together with the dental tool when clamped thereto. In one described preferred embodiment, the rotary bearing is carried by a clip removably attachable to the dental handpiece; and in another described preferred embodiment, the rotary bearing is included within the tool-clamping section of the housing.

As will be described more particularly below, the invention permits dental handpieces, particularly high-speed handpieces driven by air turbines, to be more conveniently used in a wide variety of dental operations, especially in drilling holes for implants. In addition, providing such extension pieces in different length in the form of a kit saves the substantial expenses that would be involved in requiring the various dental tools to be of different lengths.

An extension device constructed in accordance with the foregoing features of the present invention is to be sharply distinguished from that described in U.S. Pat. No. 5,098,293, in which the opposite ends of the extension device are formed with notches interlocking with complementary notches in the dental handpiece and dental tool, respectively. Such an interlocking construction produces a dissymmetry about the rotary axis, and therefore would hardly be suitable for high-speed dental handpieces, such as those operating at about 400,000 rpm, as in the preferred embodiment of the present invention.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates a prior art construction of a dental handpiece in which the extension device of the present application is particularly useful;

FIG. 2 is a side view, partly in section, illustrating an extension device constructed in accordance with the present invention included in the prior art dental handpiece of FIG. 1;

FIG. 3 is a three-dimensional view illustrating only the extension device and the dental tool in the extension of FIG. 2;

FIG. 4 is a three-dimensional view illustrating the parts of the extension device and the dental tool of FIG. 3 in an exploded condition;

FIGS. 5 and 6 illustrate extension devices of different lengths that may be included in a kit for selective use with dental tools in order to change the effective length of the dental tool as desired according to the particular dental operation to be performed with the dental tool;

FIG. 7 illustrates a modification in the construction of the extension device to permit wrench-application thereof to the dental handpiece;

FIG. 8 is a longitudinal sectional view illustrating the extension device of FIG. 7;

FIG. 9 illustrates extension devices constructed as illustrated in FIGS. 7 and 8 in different lengths that may be included in a kit in order to perform dental operations normally requiring dental tools of different lengths;

FIG. 10 illustrates a dental handpiece including an extension device, a dental tool, and a clip removably attachable to the dental handpiece and carrying a rotary bearing engageable with the extension device in order to provide lateral support to the extension device and to the dental tool particularly for high-speed operations;

FIG. 11 illustrates the removable clip in the dental handpiece of FIG. 10, and the rotary bearing carried by it to provide lateral support for the extension device and dental tool;

and FIG. 12 illustrates another embodiment of the invention wherein the rotary bearing providing lateral support for the extension device and dental tool is located within the tool-clamping section of the dental handpiece housing.

It is to be understood that the foregoing drawings, and the description below, are provided primarily for purposes of facilitating understanding the conceptual aspects of the invention and various possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

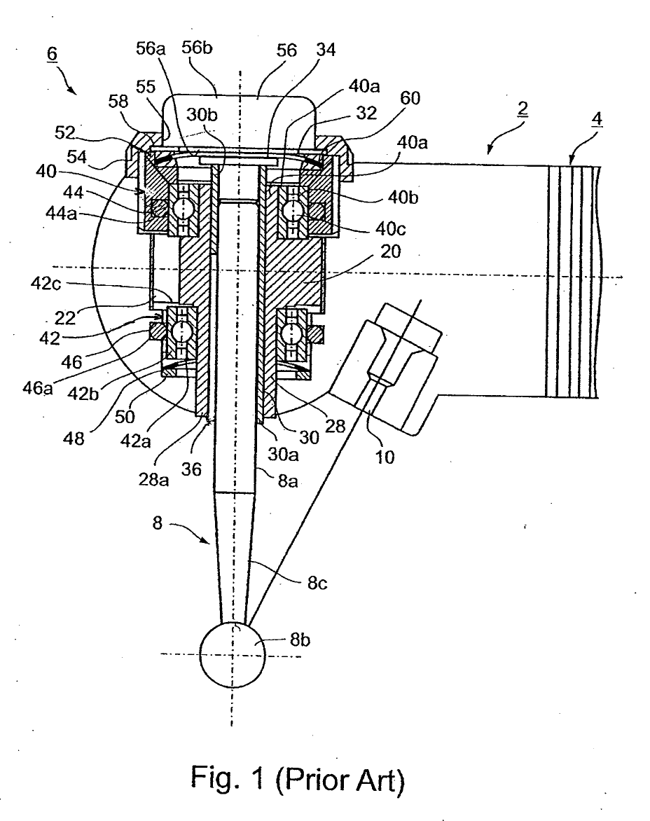

### DESCRIPTION OF A PRIOR ART DENTAL TOOL (FIG. 1)

As indicated earlier, the invention of the present application is particularly (but not exclusively) useful with the dental handpiece illustrated in the above-cited patents incorporated herein by reference. FIG. 1 illustrates the construction of such a prior art dental handpiece. It includes a housing, generally designated 2, having a hand-gripping section 4 at one end, and a tool-clamping section 6 at the opposite end for clamping thereto a dental tool 8, such as a bur or drill. Section 6 of housing 2 is further formed with a water spray nozzle 10 for discharging a water spray onto the site being worked by the dental tool 8.

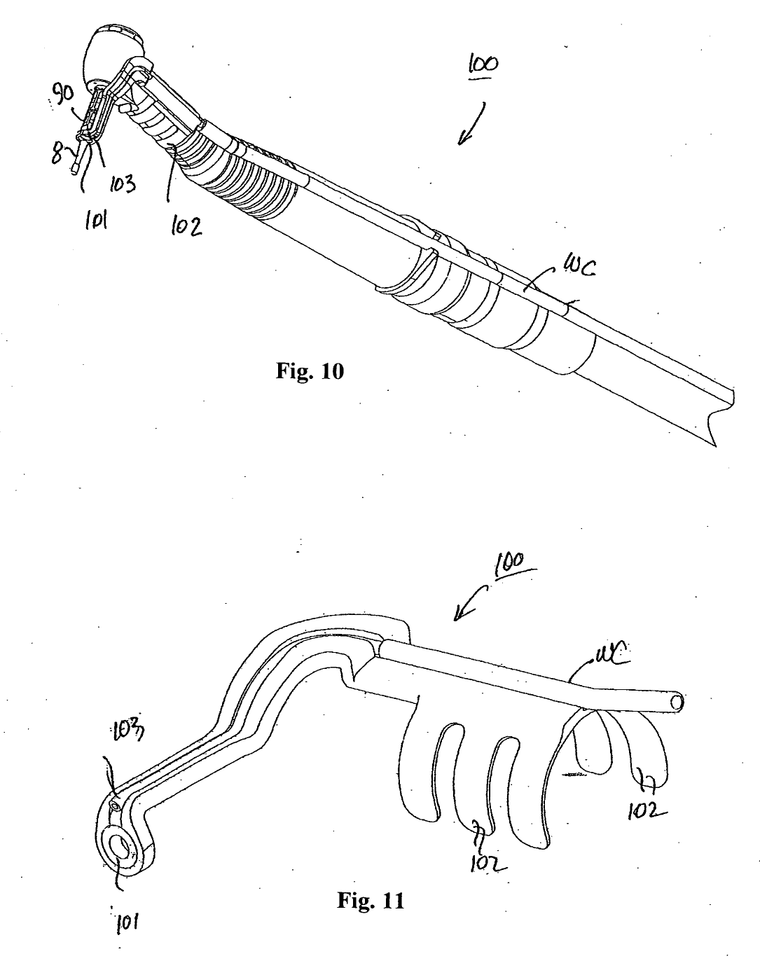

The dental handpiece illustrated in FIG. 1 is a high-speed handpiece in which compressed air is supplied via a conduit (not shown), at the back end of the handpiece, to an air turbine 20 within housing section 6 to rotate the dental tool 8 at a very high speed, e.g. in the order of 400,000 rpm. The dental handpiece includes a water conduit (e.g., WC, FIGS. 10 and 12) for introducing the water discharged in the form of a spray via nozzle 10 onto the working site of the dental tool. The dental handpiece may also include a light conduit (e.g., LC, FIG. 12) for illuminating the working site of the dental tool.

For purposes of example, dental tool 8 is shown as being of the bur type. It includes at one end a shaft 8a of uniform diameter and having a smooth, uninterrupted outer cylindrical surface; a bur 8b of spherical (or disc) shape at the opposite end; and a tapered juncture 8c between the shaft 8a and the bur 8b.

Air turbine 20 is formed with a plurality of blades 22 impinged by compressed air flowing from an inlet conduit to an outlet conduit (not shown) in order to rotate the air turbine at a very high speed. Air turbine 20 is integrally formed with a sleeve 28 of tapered configuration. One end of sleeve 28 is open, as shown at 28a, for receiving the shaft 8a of the dental tool 8. The inner diameter of tapered sleeve 28 decreases from its open end 28a to its opposite end 28b, which is also open.

Tapered sleeve 28 receives a tapered collet or chuck 30, which is also formed with an open end 30a received within the open end 28a of the tapered sleeve 28 for receiving the shaft 8a of the dental tool 8. The outer diameter of tapered collet 30 decreases from its open end 30a to its opposite end 30b. The latter end 30b is closed by an end wall or plug 32 formed within an enlarged head 34.

Tapered collet 30 is further formed with three axial slits 36 equally-spaced around its circumference. Slits 36 start at the open the end 30a and extend towards the opposite end 30b for about two-thirds the length of the tapered collet 30. Slits 36 permit the respective section of the tapered collet to contract in order to firmly clamp therein the shaft 8a of the dental tool, or to expand in order to release the shaft for purposes of removing the dental tool or reinserting another dental tool in its place.

Two ball-bearing assemblies 40, 42, are provided at the opposite ends of housing section 6 for rotatably mounting air turbine 20, its tapered sleeve 28, tapered collet 30, and dental tool 8 when clamped therein, with respect to the housing. Thus, each ball-bearing assembly 40, 42 includes: a rotary ring 40a, 42a; a static ring 40b, 42b; and a plurality of balls 40c, 42c interposed between the two rings. Housing section 6 further includes a vibration-absorbing O-ring 44, 46, for each of the ball-bearing assemblies 40, 42, received within an annular recess 44a, 46a, and a spring 48 bearing against a plastic ring 50 for preloading the static part of the bearing in order to reduce vibration during the high-speed rotation of the dental tool. A similar plastic ring 52 is provided at the opposite end of the housing section 6 cooperable with bearing assembly 40.

The latter end of housing section 6 is closed by a collar 54 threadedly attached to the housing section. Collar 54 is formed with a central opening 55 in which a button 56 is mounted to project through the opening. Button 56 includes an outwardly-projecting rim 58 around its circumference engageable by the edge of collar 54 circumscribing opening 55 receiving the button. An annular spring 60 is interposed between housing section 6 and button 56. Spring 60 is engageable with an inner surface 56a of the button to urge the button outwardly, limited by the engagement of rim 58 of the button with the undersurface of collar 54.

Pressing against the outer surface 56b of button 56 brings its inner surface 56a into engagement with the enlarged head 34 of the tapered collet 30, and thereby moves the tapered collet outwardly of the tapered sleeve 28. When this occurs, slits 36 formed in the outer section of the tapered collet 30 permit that section of the tapered collet, moving outwardly of the tapered sleeve 28, to expand and thereby to release the shaft 8a of the dental tool. The dental tool may then be manually grasped and removed from the tapered collet 30.

To insert another dental tool 8, button 56 is again depressed to move the tapered collet 30 outwardly of the tapered sleeve 28, and the dental tool is pushed inwardly into the tapered collet 30 until the end of the dental tool shaft 8a limits against the end wall 32 of the tapered collet. At that time, button 56 is released, whereupon spring 60 moves the button 56 slightly outwardly of the housing. The user then manually pushes the dental tool shaft 8a further inwardly into the housing. This also moves the tapered collet 30 further into the housing, until the enlarged head 34 of the tapered collet limits against the inner surface 56a of the button 56, at which time the dental tool 8 is firmly clamped in housing section 6 by the wedging action between the tapered collet 30 and the tapered sleeve 28.

Further details of the construction and operation of such dental handpieces are set forth in the above-cited patents, the contents of which are incorporated herein by reference. As indicated earlier, however, the extension device of the present invention could be used with other constructions of dental handpieces, such as those described in my above-referenced US patent application filed concurrently with the present application.

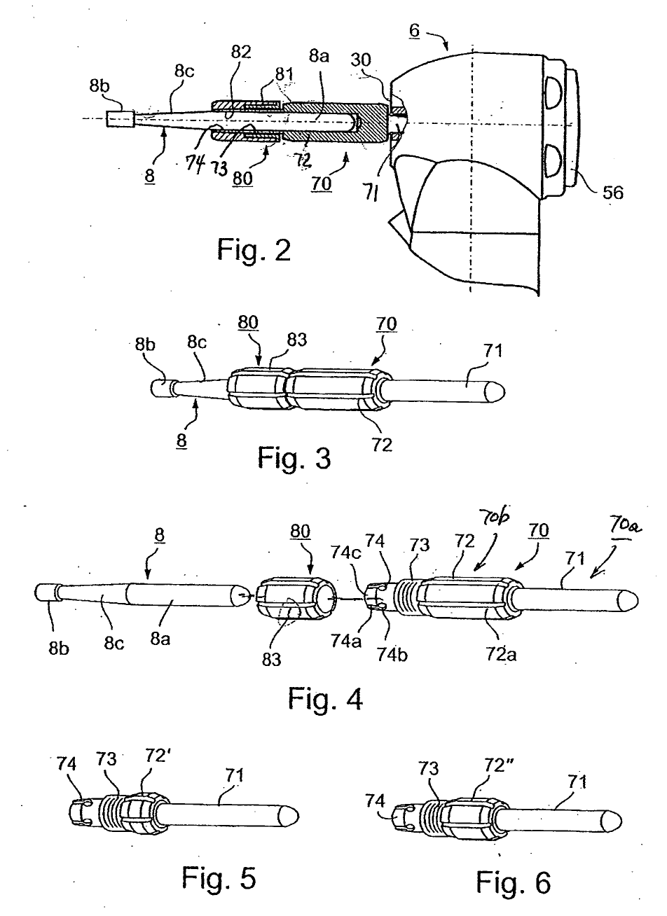

### PREFERRED EMBODIMENTS OF EXTENSION DEVICES (FIGS. 2-12)

According to the present invention, the dental handpiece, such as that illustrated in FIG. 1, may be adapted for many different dental operations, particularly in an implant operation, by providing extension devices for changing the effective length of the dental tool in a quick and convenient manner. Preferably, a plurality of such extension devices are provided in different lengths in the form of a kit, each being selectively receivable within the tool-clamping section of the housing for extending the effective length of the dental tool clamped therein according to the dental operation to be performed. Such an arrangement not only adapts the dental handpiece for more convenient use in the various dental operations, but also saves the substantial expense that would be involved if the various dental tools are provided in different lengths for the various dental operations.

FIG. 2 illustrates an extension device constructed in accordance with the present invention so as to be receivable within the tool-clamping section 6 of the dental handpiece for extending the effective length of the dental tool 8. The extension device illustrated in FIG. 2 includes an extension unit, generally designated 70, and a clamping unit, generally designated 80. FIG. 3 illustrates the extension unit 70, its clamping unit 80, and the dental tool 8 in an assembled condition; whereas FIG. 4 illustrates the foregoing in an exploded condition.

As shown particularly in FIG. 4, extension unit 70 includes two parts, namely a shaft part 70a and a sleeve part 70b integrally formed at the opposite ends of the extension unit.

Shaft part 70a is constituted of a shaft 71 of uniform diameter and having a smooth, uninterrupted, outer cylindrical surface, corresponding to that of shaft 8a of the dental tool 8, so as to be receivable into the dental handpiece in place of the dental tool.

Sleeve part 70b includes a finger-piece section 72 adjacent the shaft 71; an externally threaded section 73 for receiving the clamping unit 80; and a radially-contractible end section 74, at the opposite end of extension unit 70 from its shaft 71, for engaging the outer surface of shaft 8a of the dental tool 8 and for clamping the dental tool within the extension unit 70 when the clamping unit 80 is applied to the extension unit.

As indicated above, shaft 71 of extension unit 70 is of the appropriate diameter and length corresponding to shaft 8a of the dental tool 8 so as to be receivable within sleeve 30 of the tool-clamping section 6 of the dental handpiece in lieu of shaft 8a of the dental tool 8. Finger-piece 72 is integrally formed with shaft 71 and is further formed with an externally ribbed surface, as shown at 72a, to facilitate manipulating the extension unit when applying it to the tool-clamping section 6 of the housing.

The radially-contractible end section 74 of sleeve part 70b is split at its end by a plurality of longitudinally-extending slots 74a, each terminating in a circular opening 74b to increase the radial contractibility of the end section. The outer end of radially-contractible section 74 is formed with an outer conical surface 74c cooperable with a complementary conical surface within clamping unit 80 as described below, to securely clamp the dental tool shaft 8a within extension unit 70, when clamping unit 80 is applied.

As shown particularly in FIG. 2, clamping unit 80 is internally threaded at one end as shown at 81, for engagement with the external threads 73 of extension unit 70. The opposite end of clamping unit 80 is formed with an internal conical surface, as shown at 82, for engagement with the external conical surface 74c of extension unit 70, when the clamping unit is threaded onto the outer threaded surface 73 of the extension unit, in order to contract the end section 74 into firm engagement with the dental tool shaft 8a. As shown in FIGS. 3 and 4, the outer surface of clamping unit 80 is also formed with an outer ribbed surface 83 to facilitate application of the clamping unit to the extension unit 70 for clamping the shaft 8a of the dental tool 8 within the extension unit.

The manner of using the illustrated extension piece, including extension unit 70 and clamping unit 80, for changing the effective length of the dental tool 8 will be apparent from the above description. Assume the dental tool 8 is clamped within the tool-clamping section 6 of the dental handpiece, and it is desired to change the effective length of the dental tool in order to enable it to be used for drilling a relatively deep hole in an implant operation. This may be done in the following manner:

First, button 56 is depressed to release shaft 8a of the dental tool 8 from collet 30 of the sleeve 28 within the tool-clamping section 6 of the dental handpiece, in the manner described above. With button 56 depressed, shaft 71 of extension unit 70 is inserted into the collet 30 of the tool-clamping section 6 of the dental handpiece, in the manner described above with respect to dental shaft 8a. The button is then released, thereby firmly clamping extension unit 70 within the tool-clamping section 6 of the dental handpiece. The dental tool shaft 8a is then inserted into sleeve part 70b of extension unit 70 to the end of the sleeve part, as shown in FIG. 2. Clamping unit 80 is then applied with its internally-threaded end 81 threaded over the externally-threaded section 73 of extension unit 70. This causes the internal conical surface 82 of clamping unit 80 to engage the external conical surface 74c of extension unit 70 to firmly clamp the dental tool shaft 8a within extension unit 70.

As indicated earlier, the invention is preferably included in a dental tool kit which includes a plurality of extension units 70 of different lengths to thereby enable the user to change the effective length of the dental tool by selecting the appropriate extension unit. FIGS. 5 and 6 illustrate two such extension units which may be included in such a kit together with extension unit 70 described above with respect to FIGS. 2-4. To change the effective length of the respective extension unit, only the length of the ribbed finger-piece 72 of the extension sleeve part 70b is changed. Thus, in the extension unit illustrated in FIG. 5, the ribbed finger-piece 72 of the sleeve part 70b is of substantially shorter length, as shown at 72′, than in FIG. 4; whereas in the extension unit illustrated in FIG. 6, the ribbed finger-piece, shown at 72′, is of longer length than in FIG. 5 but shorter than in FIG. 4.

It will be appreciated that the dental kit could be supplied with a smaller number or a larger number of extension units having sleeve parts of different lengths to thereby enable the effective length of the dental tool to be varied as desired according to the particular dental operation to be performed with the dental handpiece. It will also be appreciated that the same clamping unit 80 can be used for all sizes of extension units 70.

Ribs 72a and 83 in the extension unit and clamping unit, respectively, of the above-described extension device facilitate the finger-manipulation of extension unit 70 and clamping element 80 when applying or removing a dental tool with respect to the extension device.

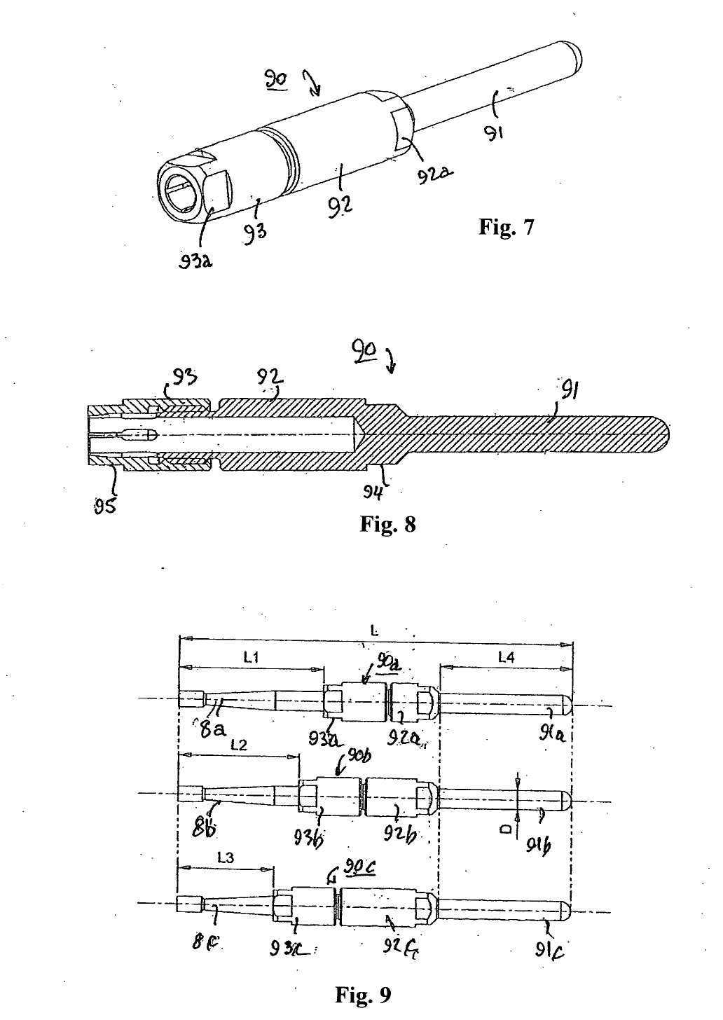

FIGS. 7 and 8 illustrate an extension device 90 of similar construction as described above, to include an extension unit having a shaft part 91 and a sleeve part 92, together with a clamping unit 93 for clamping the dental tool within the extension unit. In this case, however, the sleeve part 92 of the extension unit and the clamping unit 93 are provided with notches 94, 95, respectively, to facilitate the wrench-manipulation of these units in order to more securely clamp the extension unit to the dental handpiece, and the dental tool to the extension device.

FIG. 9 illustrates how a plurality of such extension devices, shown as 90a-90c, may be provided in a kit in order to accommodate dental tools 8a-8c of different lengths (L1-L3). Thus, the kit would include a plurality of extension devices 90a-90c, each including an extension unit having a shaft part 91a-91c of the same length (L4) and diameter (D) but with the sleeve parts 92a-92c of different lengths, corresponding to the different lengths of the dental tools. Thus, providing the user with a kit of such extension units of different size sleeve parts, but with clamping units 93a-93c of the same size, enables the user to select the appropriate extension unit according to the dental tool selected as best suited for the particular dental operation to be performed.

The foregoing constructions of extension devices are highly symmetrical with respect to the rotary axis of the dental tool, and therefore may be used with high-speed dental handpieces, e.g. operating at speeds of over 100,000 RPM, such as described above with respect to FIG. 1. Nonetheless, it may be desirable to provide additional lateral support for such extension devices.

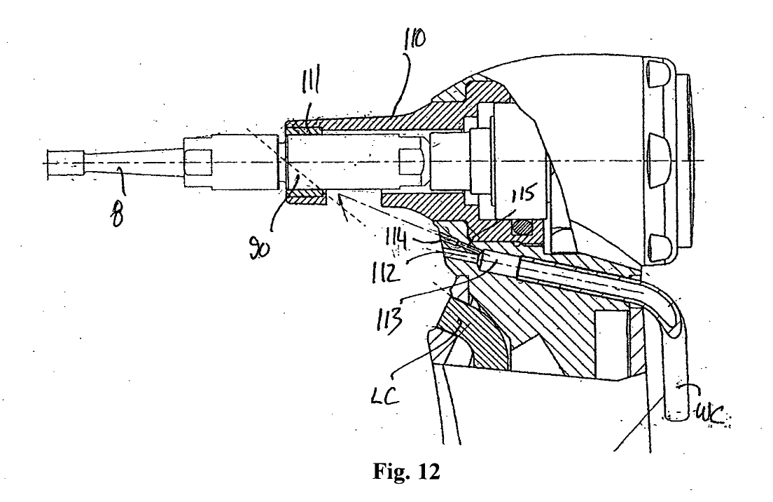

FIGS. 10 and 11 illustrate one manner of adapting an existing dental handpiece for use with an extension device, as described above, to provide such additional lateral support for the extension device and the dental tool when clamped thereto during a high-speed operation of the dental handpiece. Thus, as shown particularly in FIG. 11, the lateral support for the extension piece is provided by a clip, generally designated 100, removably attachable to the dental handpiece as shown in FIG. 10. One end of clip 100 carries a rotary bearing in the form of a bushing 101 enclosing the outer end of the extension device 90, in this case the sleeve part (e.g., 92, FIGS. 7, 8) of the extension unit so as to provide better lateral support of the extension device, and the dental tool clamped therein, during the high-speed operation of the dental handpiece. Clip 100 is removably attachable to the dental handpiece by spring fingers 102. As shown in FIG. 11, the end of the spring clip adjacent to its rotary bearing 101 includes a water discharge nozzle 103 supplied with water via water conduit WC, to discharge water in the form of a spray onto the working site of the dental tool.

FIG. 12 illustrates another manner of providing such additional lateral support. In this case, the tool-clamping section of the dental piece housing is elongated, as shown at 110, and mounts the rotary bearing or bushing 111 engageable with the sleeve part (e.g., 92, FIGS. 7, 8) of the extension unit of extension device 90 to provide the lateral support of the extension device and the dental tool 8 clamped therein.

In the embodiment illustrated in FIG. 12, the tool-clamping section 110 of the housing is formed with a passageway 112 for receiving a recessed water-spray nozzle 113 supplied by water via the water conduit WC, in order to discharge a water spray onto the working site of the dental tool. This section of the housing includes a second nozzle 114 supplied with water via a branch passageway 115 for discharging another water spray onto the bearing or bushing 111 to prevent over-heating during the high-speed operation of the dental handpiece. As also seen in FIG. 12, the tool-clamping section of the housing also includes a light conduit LC, such as an optical fiber, for illuminating the working site.

It will be appreciated that the clip illustrated in FIG. 11 could also be provided with the second nozzle and the light conduit shown in FIG. 12.

While the invention has been described with respect to several preferred embodiments, it will be appreciated that these are set forth merely for purposes of example, and that many other variations, modifications and applications of the invention may be made.

What is claimed is:

1. An extension device for dental handpieces for extending the effective length of a dental tool to be clamped within the dental handpiece, said extension device comprising:
an extension unit including a shaft at one end to be clamped within said dental handpiece instead of a dental tool, and a sleeve having a radially-contractible section at the opposite end for receiving a dental tool;
and a clamping unit applicable over said radially-contractible section of said sleeve, after having received a dental tool, for securely clamping the dental tool within said sleeve of the extension unit.

2. The extension device according to claim 1, wherein said shaft of the extension unit has a uniform outer diameter and a smooth, uninterrupted outer cylindrical surface, such as to enable the extension unit to be clamped within a high-speed dental handpiece to operate at over 100,000 RPM.

3. The extension device according to claim 1,
wherein said sleeve of the extension unit is integrally formed with said shaft and includes an externally-threaded surface between said radially-contractible section of said sleeve and said shaft;
and wherein said clamping unit includes an internally-threaded surface threadable within said externally-threaded surface of the sleeve, and an inner conical surface engageable with said radially-contractible section of the sleeve, after having received a dental tool, for securing clamping the dental tool therein.

4. The extension device according to claim 3, wherein said radially-contractible section of the sleeve is longitudinally split to facilitate the contraction thereof.

5. The extension device according to claim 4, wherein said sleeve of the extension unit further includes, between said shaft and said externally-threaded surface, a finger-piece section having an outer ribbed surface to facilitate finger manipulation of the extension unit.

6. The extension device according to claim 5, wherein said clamping unit is formed with an outer ribbed surface to facilitate finger-manipulation of the clamping unit.

7. The extension device according to claim 4, wherein said extension unit and said clamping unit are both formed with notched outer surfaces to facilitate wrench-manipulation of the two units of the extension device when clamping the extension unit within the dental handpiece, and the dental tool within the extension unit.

8. A dental handpiece, comprising:
a housing including a hand-gripping section at one end, and a tool clamping section at the opposite end;
a collet within said tool-clamping section of the housing for releasably clamping therein the shaft of a dental tool;
and an extension device for extending the effective length of a dental tool to be clamped within the dental handpiece; said extension device comprising;
an extension unit including a shaft at one end to be clamped within said dental handpiece instead of a dental tool, and a sleeve having a radially-contractible section at the opposite end for receiving a dental tool;
and a clamping unit applicable over said radially-contractible section of said sleeve, after having received a dental tool, for securely clamping the dental tool within said sleeve of the extension unit.

9. The dental handpiece according to claim 8, wherein said shaft of the extension unit has a uniform outer diameter and a smooth, uninterrupted outer cylindrical surface, such as to enable the extension unit to be clamped within a high-speed dental handpiece to operate at over 100,000 RPM.

10. The dental handpiece according to claim 8, wherein said sleeve of the extension unit is integrally formed with said shaft and includes an externally-threaded surface between said radially-contractible section and said shaft;
and wherein said clamping unit includes an internally-threaded surface threadable within said externally-threaded surface of the sleeve, and an inner conical surface engageable with said radially-contractible section of the sleeve, after having received a dental tool, for securing clamping the dental tool therein.

11. The dental handpiece according to claim 10, wherein said radially-contractible section of the sleeve is longitudinally split to facilitate the contraction thereof.

12. The dental handpiece according to claim 11, wherein said sleeve of the extension unit further includes, between said shaft and said externally-threaded surface, a finger-piece section having an outer ribbed surface to facilitate finger manipulation of the extension unit.

13. The dental handpiece according to claim 12, wherein said clamping unit is formed with an outer ribbed surface to facilitate finger-manipulation of the clamping unit.

14. The dental handpiece according to claim 11, wherein said extension unit and said clamping unit are both formed with notched outer surfaces to facilitate wrench-manipulation of the two units of the extension device when clamping the extension unit within the dental handpiece, and the dental tool within the extension unit.

15. The dental handpiece according to claim 8, wherein said dental handpiece further includes a rotary bearing or bushing engageable with said extension device, when mounted within said housing, to provide lateral support therefor during the rotation of the extension device together with the dental tool when clamped thereto.

16. The dental handpiece according to claim 15, wherein said rotary bearing or bushing of the lateral support encloses a part of the extension unit of the extension device when received within said tool-clamping section of the housing.

17. The dental handpiece according to claim 15, wherein said dental handpiece includes a first nozzle located to discharge a water spray in the working region of the dental tool, and a second nozzle located to discharge a water spray onto said rotary bearing or bushing.

18. The dental handpiece according to claim 15, wherein said rotary bearing or bushing is carried by a clip removably attachable to said dental handpiece.

19. The dental handpiece according to claim 18, wherein said clip carries a water discharge conduit extending along the dental handpiece, and a nozzle located to discharge a water spray in the working region of said rotary bearing or bushing is carried by said tool-clamping section of the housing.

20. The dental handpiece according to claim 15, wherein said rotary bearing or bushing is carried by said tool-clamping section of the housing.
